(19) United States
(12) Patent Application Publication
(10) Pub. No.: US 2024/0057618 A1
(43) Pub. Date: Feb. 22, 2024

(54) CONTROLLABLE ROTATING PIZZA OVEN

(71) Applicant: Guangdong Sheng Bao Industrial Co., Ltd., Foshan (CN)

(72) Inventor: Puyu YU, Foshan (CN)

(21) Appl. No.: 18/499,177

(22) Filed: Oct. 31, 2023

Related U.S. Application Data
(63) Continuation of application No. 17/597,856, filed on Jan. 26, 2022.

(51) Int. Cl. A21B 1/44; A21B 1/28

(52) U.S. Cl. CPC A21B 1/44; A21B 1/28

(57) ABSTRACT

A controllable rotating pizza oven includes an oven body provided therein with a baking chamber and a combustion chamber; the baking chamber is provided therein with a baking pan and a controllable rotating device; the controllable rotating device includes a rotating tray, a drive shaft and a control lever; the baking pan is provided on the rotating tray; the rotating tray is fit with an upper end of the drive shaft; a lower end of the drive shaft penetrates the oven body; the control lever is provided on a bottom surface of the oven body, and is meshed with the drive shaft to drive the rotating tray to rotate in the baking chamber.

### CROSS-REFERENCE TO RELATED APPLICATIONS

This application is a Continuation of the U.S. application Ser. No. 17/597,856 filed on Jan. 26, 2022, and entitled “CONTROLLABLE ROTATING PIZZA OVEN”, now pending, the entire disclosures of which are incorporated herein by reference.

### TECHNICAL FIELD

The present disclosure relates to pizza ovens, and in particular to a controllable rotating pizza oven.

### BACKGROUND

With the improvement of living standards, consumers are increasingly favoring delicious pizzas, especially those baked on a stone with charcoal.

A traditional stone oven for making pizzas includes an oven body. The oven body is provided therein with a combustion chamber and a baking chamber. The baking chamber is provided therein with a stone, and the combustion chamber is used to heat with charcoal. The heat generated by the burning of the charcoal heats the stone to bake the pizza placed on the stone.

The traditional pizza oven has the following shortcomings in practical application:

1) The stone is fixed in the baking chamber, but the heat in the baking chamber is hard to distribute evenly, and it is high near the combustion chamber. During baking, the pizza needs to be taken out of the oven and re-placed in the oven with the low-heated side facing the combustion chamber. The operation is cumbersome, but if the pizza is baked always in one direction, the baking quality and taste of the pizza will be affected.

2) The traditional pizza oven needs to be opened multiple times to change the position of the pizza, which prolongs the baking time and increases the production cost.

3) The combustion chamber is behind the baking chamber. If the baking chamber in front is opened when the charcoal in the combustion chamber is burning, the fire will burn backwards, posing a safety hazard.

4) The burning of the charcoal produces a lot of smoke and dust, which is easy to contaminate the pizza. In addition, it is cumbersome and dangerous to clean the charcoal residue and manually add charcoal.

### SUMMARY

In order to overcome the shortcomings of the prior art, an objective of the present disclosure is to provide a controllable rotating pizza oven. The present disclosure is simple in structure, convenient to operate, and can control the baking pan to rotate so as to bake the pizza at an even temperature. The present disclosure can reduce the frequency of opening the pizza oven, improve the baking efficiency, reduce the danger of burning backwards, ensure the baking quality of the pizza, and facilitate the addition of charcoal and cleaning of the residue.

The objective of the present disclosure is achieved as follows. A controllable rotating pizza oven includes an oven body provided therein with a baking chamber and a combustion chamber; the baking chamber is provided therein with a baking pan and a controllable rotating device; the controllable rotating device includes a rotating tray, a drive shaft and a control lever; the baking pan is provided on the rotating tray; the rotating tray is fit with an upper end of the drive shaft; a lower end of the drive shaft penetrates the oven body; the control lever is provided on a bottom surface of the oven body, and is meshed with the drive shaft to drive the rotating tray to rotate in the baking chamber.

Optimally, the lower end of the drive shaft may be provided with an external gear; and the control lever may be provided with a connecting tooth group meshed with the external gear.

Optimally, a middle part of the control lever may be positioned on the bottom surface of the oven body by a screw; a connecting end of the control lever may be provided with an arc edge; and the connecting tooth group may be provided on the arc edge.

Optimally, two ends of the arc edge may be provided with limiting protrusions for limiting a moving position of the control lever; and the limiting protrusions may be distributed on two ends of the connecting tooth group.

Optimally, a partition plate may be provided in the oven body; the partition plate partitions the oven body into the baking chamber and the combustion chamber which may be distributed side by side; the baking chamber and the combustion chamber may be respectively provided with a pizza material inlet and a fuel inlet that may be symmetric; and the pizza material inlet and the fuel inlet may be provided with a combustion door.

Optimally, the oven body may be provided with a smoke exhaust pipe; the smoke exhaust pipe may be provided above the baking chamber; and the baking chamber may be communicated with the combustion chamber and the smoke exhaust pipe, respectively.

Optimally, a top of the oven body may be provided with a temperature detector for detecting a temperature of the baking chamber; and the temperature detector may be connected to the baking chamber.

Optimally, the combustion chamber may be provided therein with a fuel receptacle; and the fuel receptacle may be provided with an inclined partition screen; and the inclined partition screen may be obliquely provided in the fuel receptacle to partition the fuel receptacle into an upper fuel position and a lower dust position distributed up and down.

Optimally, a handle may be provided on an outer side of the fuel receptacle.

The present disclosure has the following advantages:

1) The present disclosure designs a controllable device with a rotating tray, a drive shaft and a control lever. During baking, the control lever is moved to drive the rotating tray to rotate 180 degrees. In this way, the baking pan rotates in the baking chamber to bake the pizza on the rotating baking pan at an even temperature, so as to improve the taste of the pizza.

2) Because the rotating tray drives the baking pan to rotate 180 degrees, the pizza oven avoids manual adjustment of the pizza, effectively reduces the frequency of opening the baking chamber, saves the baking time, and reduces the cost of pizza production.

3) The controllable device reduces the frequency of opening the pizza oven, effectively reduces the risk of burning backwards, and increases the safety and reliability of use.

4) The temperature detector monitors the temperature in the baking chamber in time to ensure the baking quality of the pizza.

5) Because the baking chamber is communicated with the combustion chamber and the smoke exhaust pipe, the smoke generated by the fuel passes over the baking chamber and is quickly discharged, which makes the most of the smoke heat and keeps the pizza safe to eat.

6) The fuel receptacle is fit with the handle, which is convenient to add charcoal and clean the residue, and is safe to operate.

### BRIEF DESCRIPTION OF DRAWINGS

FIG. 1 is a structural view of a preferred embodiment according to the present disclosure;

FIG. 2 is a structural view of the preferred embodiment from another angle according to the present disclosure;

FIG. 3 is a top view of the preferred embodiment according to the present disclosure; and

FIG. 4 is a sectional view of the preferred embodiment according to the present disclosure.

### DETAILED DESCRIPTION OF THE EMBODIMENTS

The present disclosure is further described below with reference to the drawings.

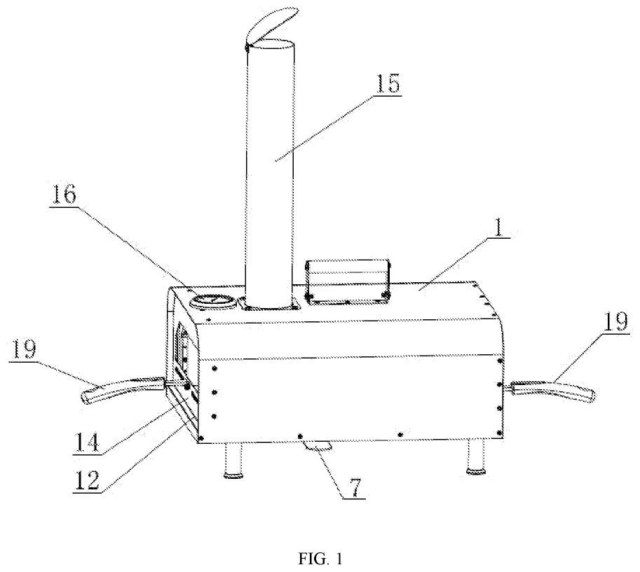

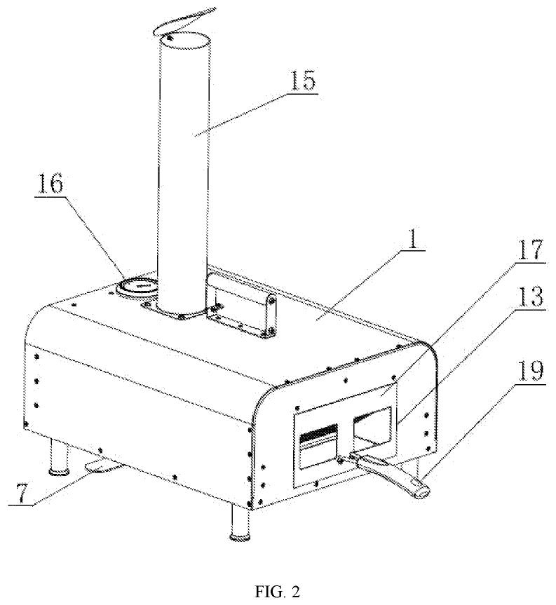

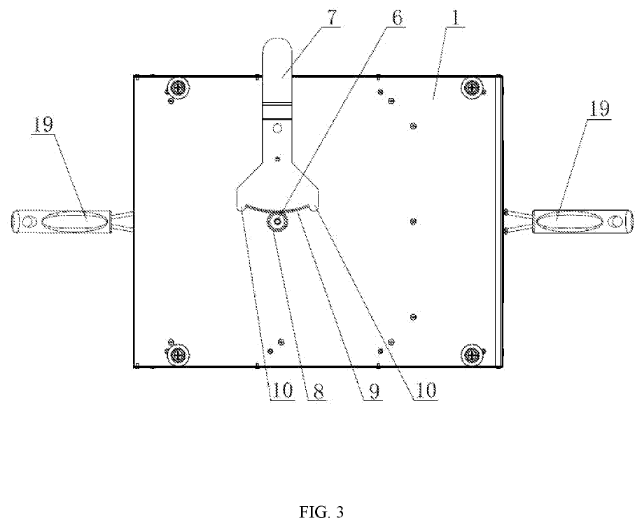

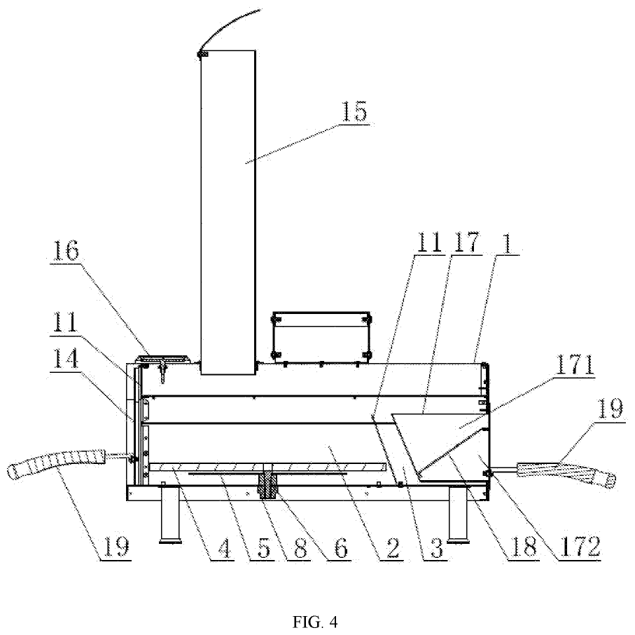

As shown in FIGS. 1 to 4, the present disclosure provides a controllable rotating pizza oven. The pizza oven includes an oven body 1, and the oven body 1 is provided therein with a baking chamber 2 and a combustion chamber 3. The baking chamber 2 is provided therein with a baking pan 4 and a controllable rotating device. The controllable rotating device includes a rotating tray 5, a drive shaft 6, and a control lever 7. The baking pan 4 is provided on the rotating tray 5. The rotating tray 5 is fit with an upper end of the drive shaft 6. A lower end of the drive shaft 6 penetrates the oven body 1. The control lever 7 is provided on a bottom surface of the oven body 1, and is meshed with the drive shaft 6 to drive the rotating tray 5 to rotate in the baking chamber 2.

During baking, the control lever 7 is moved to drive the rotating tray 5 to rotate. In this way, the baking pan 4 rotates in the baking chamber 2 to bake the pizza on the rotating baking pan 4 at an even temperature, so as to improve the taste of the pizza.

In actual operation, the lower end of the drive shaft 6 is provided with an external gear 8. The control lever 7 is provided with a connecting tooth group 9 meshed with the external gear 8, so as to effectively control a rotation speed and angle of the rotating tray 5, thereby achieving even-temperature baking of the pizza. A middle part of the control lever 7 is positioned on the bottom surface of the oven body 1 by a screw. A connecting end of the control lever 7 is provided with an arc edge, and the connecting tooth group 9 is provided on the arc edge. Meanwhile, two ends of the arc edge are provided with limiting protrusions 10 for limiting a moving position of the control lever 7. The limiting protrusions 10 are distributed on two ends of the connecting tooth group 9. When the control lever 7 is moved, the rotating tray 5 drives the baking pan 4 to rotate 180 degrees. This design improves the control stability of the controllable rotating device, avoids manual adjustment of the pizza, effectively reduces the frequency of opening the baking chamber, saves the baking time, and reduces the cost of pizza production.

Referring to FIGS. 1 to 4, a partition plate 11 is provided in the oven body 1. The partition plate 11 partitions the oven body 1 into the baking chamber 2 and the combustion chamber 3 which are distributed side by side. The baking chamber 2 and the combustion chamber 3 are respectively provided with a pizza material inlet 12 and a fuel inlet 13 that are symmetrical. The pizza material inlet 12 is provided with a baking cover 14. The controllable device reduces the frequency of opening the pizza oven, effectively reduces the risk of burning backwards, and increases the safety and reliability of use.

The baking cover 14 is provided with a handle 19, which is convenient for taking the pizza. A top of the oven body 1 is provided with a temperature detector 16 for detecting a temperature of the baking chamber 2. The temperature detector 16 is connected to the baking chamber 2. The temperature detector 16 monitors the temperature in the baking chamber 2 in time to ensure the baking quality of the pizza.

In addition, the oven body 1 is provided with a smoke exhaust pipe 15. The smoke exhaust pipe 15 is provided above the baking chamber 2. The baking chamber 2 is communicated with the combustion chamber 3 and the smoke exhaust pipe 15, respectively. The smoke generated by the fuel passes over the baking chamber 2 and is quickly discharged, which makes the most of the smoke heat and keeps the pizza safe to eat.

Referring to FIGS. 1 to 4, the combustion chamber 3 is provided therein with a fuel receptacle 17. The fuel receptacle 17 is provided with an inclined partition screen 18. The inclined partition screen 18 is obliquely provided in the fuel receptacle 17 to partition the fuel receptacle 17 into an upper fuel position 171 and a lower dust position 172 distributed up and down.

During use, due to the inclined partition screen 18, charcoal is accumulated on the upper fuel position 171 toward the baking chamber 2. During combustion, due to the symmetrical distribution of the pizza material inlet 12 and the fuel inlet 13, the air circulation is accelerated and the charcoal is fully burned. After burning, the dust passes through the inclined partition screen 18 and falls to the lower dust position 172, which facilitates the effective collection of dust and facilitates cleaning.

A handle 19 is provided on an outer side of the fuel receptacle 17, which is convenient to add charcoal and clean the residue, and is safe to operate.

While considerable emphasis has been placed on the structures of the preferred embodiments and the processes and relationships in creating these preferred embodiments, it will be appreciated that many modifications and alterations can be made in the embodiments herein illustrated and described without departing from the principals of the invention. For instance, the mat may be used as a kitchen mat or otherwise in the home. Such modifications and alterations will occur to others upon the reading and understanding of this specification. It is intended to include all such modifications and alterations insofar as they come within the scope of the appended claims or the equivalents thereof

What is claimed is:

1. A controllable rotating pizza oven, comprising an oven body (1) provided therein with a baking chamber (2) and a combustion chamber (3); wherein the baking chamber (2) is provided with a baking pan (4) and a controllable rotating device; the controllable rotating device comprises a rotating tray (5), a drive shaft (6) and a control lever (7); the baking pan (4) is provided on the rotating tray (5); the rotating tray (5) is fit with an upper end of the drive shaft (6); a lower end of the drive shaft (6) penetrates the oven body (1); and the control lever (7) is provided on a bottom surface of the oven body (1), and is meshed with the drive shaft (6) to drive the rotating tray (5) to rotate in the baking chamber (2).

2. The controllable rotating pizza oven according to claim 1, wherein the lower end of the drive shaft (6) is provided with an external gear (8); and the control lever (7) is provided with a connecting tooth group (9) meshed with the external gear (8).

3. The controllable rotating pizza oven according to claim 2, wherein a middle part of the control lever (7) is positioned on the bottom surface of the oven body (1) by a screw; a connecting end of the control lever (7) is provided with an arc edge; and the connecting tooth group (9) is provided on the arc edge.

4. The controllable rotating pizza oven according to claim 3, wherein two ends of the arc edge are provided with limiting protrusions (10) for limiting a moving position of the control lever (7); and the limiting protrusions (10) are distributed on two ends of the connecting tooth group (9).

5. The controllable rotating pizza oven according to claim 1, wherein a partition plate (11) is provided in the oven body (1); the partition plate (11) partitions the oven body (1) into the baking chamber (2) and the combustion chamber (3) which are distributed side by side; the baking chamber (2) and the combustion chamber (3) are respectively provided with a pizza material inlet (12) and a fuel inlet (13) that are symmetrical; and the pizza material inlet (12) is provided with a baking cover (14).

6. The controllable rotating pizza oven according to claim 1, wherein the oven body (1) is provided with a smoke exhaust pipe (15); the smoke exhaust pipe (15) is provided above the baking chamber (2); and the baking chamber (2) is communicated with the combustion chamber (3) and the smoke exhaust pipe (15), respectively.

7. The controllable rotating pizza oven according to claim 6, wherein a top of the oven body (1) is provided with a temperature detector (16) for detecting a temperature of the baking chamber (2); and the temperature detector (16) is connected to the baking chamber (2).

8. The controllable rotating pizza oven according to claim 1, wherein the combustion chamber (3) is provided therein with a fuel receptacle (17); and the fuel receptacle (17) is provided with an inclined partition screen (18); and the inclined partition screen (18) is obliquely provided in the fuel receptacle (17) to partition the fuel receptacle (17) into an upper fuel position (171) and a lower dust position (172) distributed up and down.

9. The controllable rotating pizza oven according to claim 8, wherein a handle (19) is provided on an outer side of the fuel receptacle (17).

10. The controllable rotating pizza oven according to claim 2, wherein a partition plate (11) is provided in the oven body (1); the partition plate (11) partitions the oven body (1) into the baking chamber (2) and the combustion chamber (3) which are distributed side by side; the baking chamber (2) and the combustion chamber (3) are respectively provided with a pizza material inlet (12) and a fuel inlet (13) that are symmetrical; and the pizza material inlet (12) is provided with a baking cover (14).

11. The controllable rotating pizza oven according to claim 3, wherein a partition plate (11) is provided in the oven body (1); the partition plate (11) partitions the oven body (1) into the baking chamber (2) and the combustion chamber (3) which are distributed side by side; the baking chamber (2) and the combustion chamber (3) are respectively provided with a pizza material inlet (12) and a fuel inlet (13) that are symmetrical; and the pizza material inlet (12) is provided with a baking cover (14).

12. The controllable rotating pizza oven according to claim 4, wherein a partition plate (11) is provided in the oven body (1); the partition plate (11) partitions the oven body (1) into the baking chamber (2) and the combustion chamber (3) which are distributed side by side; the baking chamber (2) and the combustion chamber (3) are respectively provided with a pizza material inlet (12) and a fuel inlet (13) that are symmetrical; and the pizza material inlet (12) is provided with a baking cover (14).

13. The controllable rotating pizza oven according to claim 5, wherein a partition plate (11) is provided in the oven body (1); the partition plate (11) partitions the oven body (1) into the baking chamber (2) and the combustion chamber (3) which are distributed side by side; the baking chamber (2) and the combustion chamber (3) are respectively provided with a pizza material inlet (12) and a fuel inlet (13) that are symmetrical; and the pizza material inlet (12) is provided with a baking cover (14).

14. The controllable rotating pizza oven according to claim 2, wherein the combustion chamber (3) is provided therein with a fuel receptacle (17); and the fuel receptacle (17) is provided with an inclined partition screen (18); and the inclined partition screen (18) is obliquely provided in the fuel receptacle (17) to partition the fuel receptacle (17) into an upper fuel position (171) and a lower dust position (172) distributed up and down.

15. The controllable rotating pizza oven according to claim 3, wherein the combustion chamber (3) is provided therein with a fuel receptacle (17); and the fuel receptacle (17) is provided with an inclined partition screen (18); and the inclined partition screen (18) is obliquely provided in the fuel receptacle (17) to partition the fuel receptacle (17) into an upper fuel position (171) and a lower dust position (172) distributed up and down.

16. The controllable rotating pizza oven according to claim 4, wherein the combustion chamber (3) is provided therein with a fuel receptacle (17); and the fuel receptacle (17) is provided with an inclined partition screen (18); and the inclined partition screen (18) is obliquely provided in the fuel receptacle (17) to partition the fuel receptacle (17) into an upper fuel position (171) and a lower dust position (172) distributed up and down.

17. The controllable rotating pizza oven according to claim 5, wherein the combustion chamber (3) is provided therein with a fuel receptacle (17); and the fuel receptacle (17) is provided with an inclined partition screen (18); and the inclined partition screen (18) is obliquely provided in the fuel receptacle (17) to partition the fuel receptacle (17) into an upper fuel position (171) and a lower dust position (172) distributed up and down.
